(19) United States
(12) Patent Application Publication
(10) Pub. No.: US 2004/0113103 A1
(43) Pub. Date: Jun. 17, 2004

(54) Terahertz and mid-infrared probing apparatus with high repetition rate pulses, and methods of using same

(76) Inventor: Stanislav V. Zhilkov, Philadelphia, PA (US)

Correspondence Address: Albert T. Keyack, 1005 Glendevon Drive, Ambler, PA, 19002, US

(21) Appl. No.: 10/723,060

(22) Filed: Nov. 26, 2003

Related U.S. Application Data
(63) Continuation-in-part of application No. 10/447,869, filed on May 29, 2003.
(60) Provisional application No. 60/429,023, filed on Nov. 25, 2002.

(51) Int. Cl. H01J 65/00

(52) U.S. Cl. 250/504 R

(57) ABSTRACT

An apparatus for producing the sequence of terahertz electromagnetic pulses by driven particle beam is disclosed. Initial electromagnetic beam (em-beam) is being sent to metal-dielectric structure the way that the field of said em-beam partially transforms into delayed electromagnetic wave, in preferred embodiment into the surface evanescent mode, and the beam of charged particles (cp-beam), in preferred embodiment electrons, is also being sent to said structure the way that the particles' kinetic energy partially transforms into energy of the delayed electromagnetic wave having the same phase-frequency's characteristics as transformed field of em-beam; at that, transformation of em-beam and excitation of wave by particles' cp-beam commonly take place at the same small space region, which is localized by said metal-dielectric structure. Delayed electromagnetic wave, which is generated by particle beam, is summarized with the field of em-beam, which is transformed on said structure, so, the particle beam influents on intensity of em-beam has observed after passing the region of localized transformation. The controlled changing of parameters of particle beam in interaction region leads to adequate changing of intensity of the em-beam passed through said region and this way the predetermined forming of electromagnetic pulses is realized. Alternatively, sequence of electromagnetic pulses is produced without initial electromagnetic beam directed to metal-dielectric structure, but due to presence of driven particle beam only.

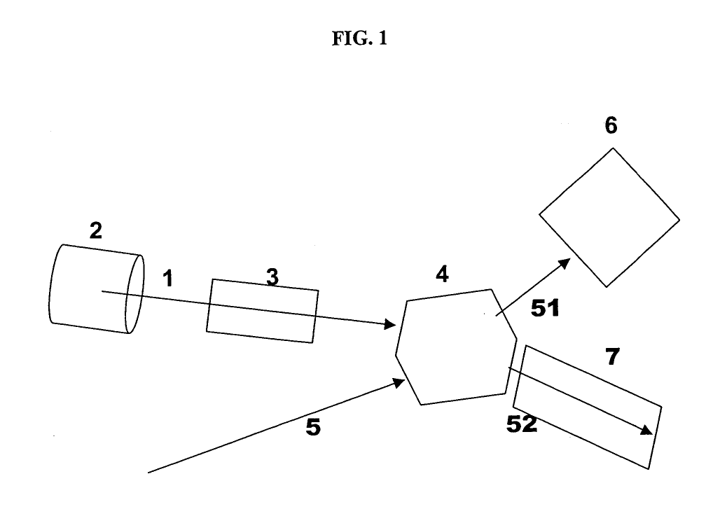

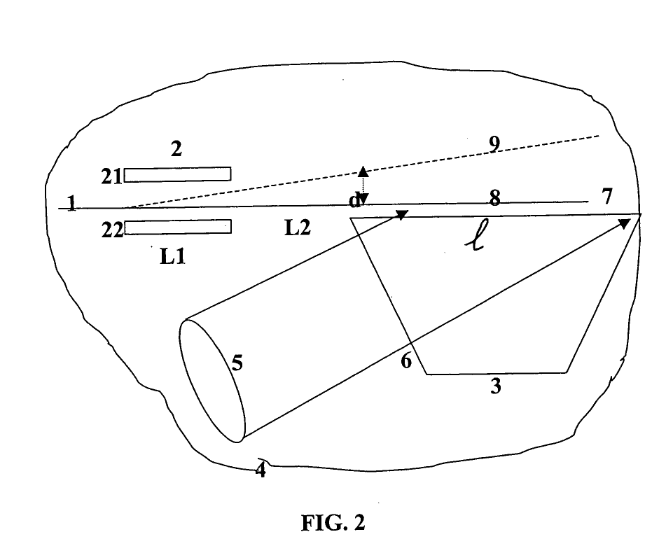

The invention is directed to improved laser systems, and in particular, methods and apparatus for both the imaging an internal media for studying objects, e.g., medical imaging, and external probing of pre-surfaces region for studying objects, e.g., radar and the like.

The invention provides methods for producing and using terahertz or infrared pulses by accelerating charged particles so as to establish a positive net emission of electromagnetic radiation. In accordance with the invention the method comprises the a manipulating means for driving accelerated particles, a transforming means for transfiguration of initial em-beam into delayed electromagnetic wave and also to provide converting kinetic energy of charged particles into an energy of the same delayed electromagnetic wave. The steps of transfiguration and converting take place simultaneously in the same interaction region, which has been formed by wave-guiding structure. Said transforming means may be implemented, e.g., as said wave-guiding structure having suitable geometric configuration and dielectric/metal properties. Said manipulating means may be implemented, e.g., as a deflector, which is driven by small voltage; alternatively, a “buncher” or other charged particles beam's properties changing system can be used for said manipulation.

Exploitation of the pulses is permits them to be directed as a sequence of pulses into the object or media being studied and analyzing the data. The pulses are detected by detecting means after passing the sequence through the object. Alternatively, data can be collected and analyzed by detecting means that register the pulses redirected (e.g., reflected, refracted, scattered, etc.) from the object or media being studied.

### BACKGROUND OF THE INVENTION

1. General State of the Art

Vacuum electronic devices are successfully operating up to 100 GHz (wavelengths of approximately 3 mm and higher). For example, research groups, which develop the high power generators of Giroklystron type, demonstrated significant progress during past several years. Optical range up to the near-infrared band (wavelengths ˜10 micron and less; frequencies ˜30 THz and more) use solid-state devices including semiconductor lasers and gas powerful lasers for wave generation. The terahertz band of the electromagnetic (E-M) spectrum exists between the mid-infrared band and the microwave band. Loosely defined, the terahertz band encompasses that part of the frequency spectrum that includes the frequencies ranging from about 0.3-10.0 THz, or equivalently, the wavelengths ranging from about 1.0-0.03 millimeters. In the art, the terahertz band is also known as the far-infrared band or the sub millimeter band.

The terahertz band is one of the last spectral regions where compact, powerful, coherent sources are available. High-performance t-ray systems, such as periodically-probing sensors or fast-made imaging systems, need robust pulsed t-ray sources having tunable, precision narrow-band, low cost means for driving the radiation power. THz (or far-infrared, or sub millimeter) and mid-infrared (3.0-30.0 micron) wavelength ranges are of interest both for quantum electronics developers and vacuum electronics ones, because of absence devices and systems that can utilize these frequencies for scanning or imaging. Although the range is important for both civilian and military applications., there has as of yet been little implementation, however, since many cases such applications require producing radiation having the form of sequence of pulses with high repetition rate.

2. Quantum Electronics Devices

Common quantum electronics methods for the generation of mid-IR or THz radiation are mostly based on high-energy, ultra-short laser pulses, which take irradiating influence either on unbiased or biased solid-state (semiconductor or nonlinear) crystals. Also, THz emission from unbiased helium gas has been reported [1] and the first demonstration of the generation of THz radiation by photo-ionization of electrically biased air with high-energy fs-pulses was presented [2].

Until recently, only thermal incoherent optical sources emitted a significant amount of light in the mid-infrared or terahertz band of the frequency spectrum. Within the last few years, several types of THz coherent optical sources have been developed for pulsed and continuous-wave applications. These THz coherent optical sources include direct coherent sources (DCS), electronically mixed electronic oscillators (EMEO), electronically mixed optical oscillators (EMOO), and optically mixed optical oscillators (OMOO). In the most successful today's case for affordable THz crystal-emitted coherent light source the output power is less than 10 microwatts, while a laser pump power of about 0.1-1.0 W [3]. Pump lasers have been demonstrated that produce initial radiation in the form of pulse having duration from ˜1 ns to ˜0.1 ps, at that, repetition rate for such pulses is usually equal to 1 kHz [4]. One-time pulsing pump lasers having integration time ˜10 s were first in use, while the THz signals with working at full repetition rate 64 MHz has also been observed [5].

3. Relativistic Vacuum Electronics Devices

THz radiation (as it shown by quantum systems' uses) can be initiated by a laser's fast pulse, and alternatively can be initiated by short relativistic electron bunches that produce terahertz Smith-Purcell (SP) radiation, terahertz Cherenkov radiation or terahertz wake fields—such emission takes place into the particle accelerating structures [6,7,8]. The idea to use the radiation of fast moving electrons has been recognized by vacuum electronics developers, who try to implement an accelerator approach into traditional microwave electronic scheme tor making a workable wavelength shorter, up to a level that produces t-rays. In this manner, the so-called Submillimetre-Wave Reflex Klystron [9], 1200 GHz Nanoklystron [10] and several other vacuum devices [11,12] have been developed during recent years.

Also there has been recent progress into the development of the vacuum tube type Generators of Diffractive Irradiation (GDI) toward THz region [13] as well as into development of very similar device, such as Smith-Purcell Free Electron Laser [14]. Initially GDI was in used in microwave band, while SP FEL had been designed for infrared band, especially. GDI and SP FEL might be joined into one generating type with near-field Cherenkov generator [15], because all these devices use a resonance surface mode for energy exchange between relativistic electrons and t-wave. All generators of this type are called as Over-Light Speed Effect (OLSE) devices. OLSE (Smith-Purcell, or Cherenkov, or Diffractive, or so-called Transition Radiation [16]) of any kind consists of charged particle radiation, when velocity of particle moving is higher than speed, with which the front of electromagnetic wave is transferred (higher than phase speed of light). Regular Free Electron Lasers (FEL), having the necessary undulator with a very high magnetic field of sophisticated configuration are rather expensive, but SP FEL or GDI does not require use of such field. Also, a regular FEL is of much larger physically compared with GDI/SP FEL.

Klystron type generator as well as regular FEL can emit sequence of THz pulses. For this purpose a special cathode or electron gun should be used, which produces a sequence of the electron bunches. However, producing of these bunches is also rather expensive, while repetition rate for THz pulses has not achieved high value in any of such generators.

The current of an electron beam, which is needed for forming the pulses into OLSE schemes, and robust repetition rate, which can be reached, are quite appropriate to be realized and detected by technology known in the art, as demonstrated below.

1. Comparison of Threshold Current into GDI, SP FEL and Grating Cherenkov Schemes

First, GDI was simultaneously developed with Orotron four decades ago and had very similar design. Many kinds of GDI have been proposed by Shestopalov's group [17,18,19,13], including metal grating on metal slab, metal grating on dielectric slab, dielectric grating on metal slab, GDI with several gratings, GDI with several electron beams, etc. Workable idea for all of these devices consists in an exploitation of the energy exchange between electron beam and irradiated field, at that, the exchange is provided through electromagnetic surface wave (ESW), which takes place into small spatial region near the grating.

SP FEL, which had subtle difference with one-beam metal grating GDI, was experimentally studied by Walsh and Brownell [20,21,14].

The simplest analytical expression, which satisfactory describes metal grating GDI or SP FEL, has been received by Kim and Song [22]. They have obtained formula for growth rate “μ”, which can be written as:

2μ=(4π/ββ/γγ)*SQRT(exp2*EM)*SQRT((i/I)/(λ*W)) (F1),

where “β”=v/c;

“c” is speed of light;

“v” is the velocity of electron cp-beam, which equals to phase speed of evanescent mode ESW;

γ—is the relativistic factor of electrons in cp-beam;

“λ” is wavelength of initial em-beam's field in free space;

“h” is the dimension of electron cp-beam in x direction (half-thickness); h<<λ;

“W” is the dimension of electron cp-beam in y direction (width);

“b”—is the height of passing of electron cp-beam over the grating surface;

“l” is longitude of space in z direction, where electron cp-beam interacts with ESW of em-beam;

“i” is electric current of the cp-beam;

“I”=17 kA is the Alfven current;

exp2=exp(−(4π/βγ)*(b/λ));

EM—is the element of a refraction matrix of the metal grating, which provides the “quality” of coupling between electromagnetic field and electron cp-beam. In the optimal case Kim takes exp2*EM=˜0.1. Kim's theory is satisfactory corresponded with most experimental data.

Khizhniak and Zhilkov have studied and patented the device, which uses ESW over the dielectric grating in the case of total internal reflection [23,24,25]. They found so-called resonance transformation of spatial wave into ESW by such Grating Cherenkov Scheme (GCS). For GCS can be used formula, which is similar to (F1), but EM should be changed on ED—the element of a refraction matrix of the dielectric grating. In optimal case ED can reach ˜1.0, e.g. “quality” of coupling between electromagnetic field and electron beam over the dielectric grating up to several times more, than over the metal grating. Main reason, which explains this fact, is following: GCS uses single mode regime of field versus two modes regime in metal grating GDI/SP FEL.

Analysis of threshold current for metal grating GDI/SP FEL is made in the numeric example, when kinetic energy of electrons is equal to 32 keV; phase velocity of ESW is equal to β=v/c=0.34 in this case. Longitude of interaction region “1” is squeezed up to accessible limit. Limit is determined by minimum as possible of diameter of gauss optical beam and equals to couple of tens of optical wavelengths, e.g. l=10 mλ, where m—is a small integer. It's necessary for modulation to reach the growth of intensity of optical beam up to 100 a percents after passing through the interaction region; a—is a small rational, a<<1 and it is supposed to be 2 μl=a. If electron beam is squeezed up to h=0.1 λ and W=100 h=10 λ, and the “quality” of coupling between optical field and electron beam is optimal, then from (F1) the formula for necessary current in GDI/SP EEL is approximately obtained as i=1.78 a*a/(m*m). Amp. As it's seen from this formula the 13% gain (a=0.13 is enough for smooth modulation purpose) after passing l=30 λ (e.g. m=3) will be reached, if GDI/SP FEL has current i=3.3 milliamp. So, necessary current of metal grating GDI is approximately equal to necessary current of SP FEL, however, at the same time the necessary current of resonance GCS is significantly less (˜0.3 milliamp), because optimal GCS has the best “quality” of coupling between optical field and electron beam.

Of course, for the forming of pulses a deep of modulation should be greater than in mentioned-above numerical example. It means that a=0.13 is not enough for pulses forming, but it should be equal to a=0.90, approximately. For last case the numerical calculation of necessary threshold current is much more difficult, than in the case of smooth modulation, but the same conclusion is true: the calculated necessary current, which is needed for forming pulses by resonance GCS, is considerably less than calculated threshold current of metal grating GDI/SP FEL. However, recently gotten Brownell's experimental results show that generation process by SP FEL is started for threshold current, which is three times less, than Kim's theory predicts. So, both GCS and GDI/SP FEL might be considered for purpose of effective forming the THz pulses by a scheme having reasonable value of electron current.

2. Achievable Repetition Rate for OLSE Schemes

The time of interaction between transformed em-beam field and electron cp-beam approximately equals t=l/v=10 m*λ/(βc)=10 m/(βω), where ω is a frequency of field of em-beam. Consequently, the frequency of modulation of em-beam by electron beam can approximately reach:

Ω=1/nt=βω/10 nm (F2),

where “n” is so-called coefficient of packing, which shows the ratio of rather long non-modulated (or without-pulses) period to the time of interaction (when pulse is sharply appeared, existed and decreased). To be sure in our results, we can rewrite

Ω<ΩR˜0.001 ω=0.1% ω (F3),

where ΩR is the robust maximum of frequency of modulation, which can be reached.

The using of formula F3 for ΩR means that, for example, 1 THz continue wave beam might be separated into the sequence of t-pulses with repetition rate equaled to 1 GHz, while for mid-infrared case having λ=30micron (or ω=10 THz) it might be achieved the sequence of quasi-pulses with repetition rate near 10 GHz. Both 1 GHz and 10 GHz are quite appropriate repetition rate to be registered by the fastest modern detectors of THz radiation [26,27].

As it follows from F2, the theoretically predictable absolute maximum for repetition rate ΩA might be calculated, if β=0.9, m=1 and n=2 (relativistic electron beam is used for modulation, while optical beam is squeezed up to 10 λ and the without-pulses period is equal to a time of interaction). Such ΩA approximately defines as Ω/20 and equals up to 500 GHz for mid-infrared region. However, the registration of so fast 500 GHz repetition rate is not achievable by mid-infrared detectors, which have been developed until now.

### DESCRIPTION OF THE PREFERRED EMBODIEMNTS

Effective manipulating means can be implemented into OLSE emitting Arepe, scheme and this way the ultra-high repetition rate sequence of THz pulses can be formed.

1. Modulating Process

In the case of using of ESW the interaction region has effective longitude “l” and height ˜(b+h), at that, interaction takes place exactly at the time, when optical field, which should be modulate, and electron beam, which provides modulation, are simultaneously present at said region. Controlled modulation of optical field is able to be reach by changing of parameters of interacting electrac beam. In particular, before interacting process the electron beam is able to be changed by two methods at least: 1) by bunching (making discrete density) of electron beam without changing of propagating direction; 2) by deflection of electron beam from interaction region and returning to said region without changing of current density.

As far as first method is concerned, today's FEL/Particle Accelerator technique operates by relativistic flat electron bunch having parameters, for example, such as h=0.5 μm, W=50.0 μm, l=30 μm, and i=100 kA; also it was recently reported about squeezing of bunch up to h˜some tens of angstrom and l/c˜some tens of atto-second. Such bunching is over and above, than it needs for optical modulation, but the making of such bunch is very expensive in present time.

As a second method, it is can be shown that a simple pair of flat electrodes is able to provide necessary deflection/returning of electron beam by using voltage not very much than ˜1V. It's well-known if the axis of electron beam is in the middle between two parallel flat electrodes when said electrodes have no voltage, than the switching on voltage “U” provides deflection of electron beam, at that, in beginning of observation region said deflection “d” is proportionally d˜(U/γ/ββ)*L1*(0.5L1+L2)/R, where L1 is length of electrode, L2 is a distance from electrode to observation region, R is a distance between electrodes. So, if deflecting electrodes' pair is interposed before interaction region (which coincides with observation region) and, for example, β=0.34, L1=30λ, R=4 h=0.4λ, L2=m2*10λ, m2 is integer, than d is approximately equal d=1.25*(1.5+m2)*λ*abs(U)/100, where abs(U) is absolute value of U and U should be taken in volts. Taking m2=7 previous formula gives d=0.1*abs(U)*λ=abs(U)*h and it shows possibility of simple manipulating of electron beam presence into interaction region. Said manipulating is reached by small voltage, because if electron beam is deflected up to some “h” superfluously over conducting ESW surface, then interaction practically ceases. Hence, the changing of deflecting electrodes' voltage from zero to “U” leads to modulation of optical field and said modulation has the same frequency, as frequency of voltage changing. Also for realizing of second method the deflector can be made as standard usual magneto-deflecting system, which has small manipulating magnetic field. Both flat-electrodes deflector and magnetic one or, maybe, other similar deflecting system do not have some problems in modern technical realization obviously, they won't be expensive.

If for modulating light producing Smith-Purcell, or Cherenkov, or Transition Radiation effect, or any combination of OLSE effects are used, then interaction region will be small as well as in previous example, and the simple manipulation by free moving electrons is going to provide necessary modulation process, as it shows above.

2. Forming the Sequence of Pulses

The applying of a voltage from saw-tooth oscillator to deflecting electrodes will provide predictable manipulation of electron beam and this way necessary sequence of pulses is formed. Having, for example, periodically working 1 GHz saw-tooth oscillator, it might be achieved the same repetition rate for formed sequence, while irradiated field will be of terahertz band.

Such periodical driving means are realized at present, for example, in vacuum tube type electron guns, which have been recently invented for computers' monitors [28].

At that, two kinds of the forming of THz pulses should be separated from each other: 1) deep modulation of initial terahertz continue wave; 2) direct producing of the t-pulses' sequence without initial continue wave.

### EXAMPLES

1. General Definitions

Sequence of t-pulses might be used both for 1) the exploration of internal media of studying objects and 2) the external describing of studying objects. In first case the pulses are directed into studying object and it has being analyzed the info, which is registered by detecting means after passing the sequence through said object. In second case info is analyzed by detecting means, which register the pulses redirected from a surface of studying object. First-type usage might be applicable for diagnostics of plasma, biomedical probation and t-wave imaging in security systems, while second-type usage is typical for radar's needs. At the same time both types of usage can be realized for other practical applications including industrial process control, nondestructive testing and so on.

2. Diagnostics of Plasma

It is known that for THz-frequencies the plasma acts as a nearly transparent dielectric, with refractive index close to unity. Analysis of the dispersion and attenuation of terahertz pulses passing through studying media will enable properties of the plasma (collisional damping, electron density) to be characterized in an adequate manner [29,30].

More comprehensive info might be received, if the high repetition rate sequences of terahertz pulses passing through plasma are analyzed.

3. T-Wave Imaging for Security Systems

Imaging of terahertz radiation or “T-rays” represents emerging technology with significant potential for advanced, security-related inspection systems. T-rays are transmitted by many visually opaque objects and materials but reflected by others, permitting complementary imaging in transmissive and reflective modes. Many potentially harmful gases and other chemicals exhibit distinctive spectral fingerprints in the terahertz region. Together these characteristics permit T-ray-based discrimination between harmful and innocuous objects, materials, and chemicals concealed in packages and on personnel through the use of safe, low-power, non-ionizing radiation with no real or perceived health risks [31].

4. Sensor for Medical and Bioscience Applications

By combining the approaches, which have been disclosed into two previous subsections, a set of sensors for medical and bioscience applications might be developed.

5. THz and Mid-Infrared Radar

The usage of high repetition rate sequence of t-pulses opens a possibility to considerably improve radar's sensitivity, target detection, discrimination and aimpoint selection [32]. Such THz and mid-infrared radar related technologies and the associated processing techniques are useful both for military purposes and commercial ones.

### REFERENCES

1. H. Hamster, A. Sullivan, S. Gordon and R. Falkone, “Short-pulse terahertz radiation from high-intencity laser-produced plasmas” Phys. Rev. E 49, 671 (1994).

2. T. Löffler, F. Jacob, and H. G. Roskos, THz Generation by Photo-ionization of Electrically Biased Air, in ITW—International Terahertz Workshop (Sandbjerg, Denmark, Sep. 17-19, 2000)

3. T. W. Crowe, R. M. Weikle, D: S. Kurtz, K. Hui, W. L Bishop, and D. W. Porterfield, Affordable Sources of Tunable Terahertz Power, in ITW—(Sandbjerg, Denmark, Sep. 17-19, 2000)

4. J. J. Carey, D. Jones, S. Jamison, D. A. Jaroszynski, and K. Wynne, Generation and Application of High-Power THz Pulses, in ITW—(Sandbjerg, Denmark, Sep. 17-19, 2000)

5. F. Tauser, R. Huber, A. Brodschelm, and A. Leitenstorfer, Fully Coherent Generation and Detection of Femtosecond Electromagnetic Pulses Tunable between 10 THz and 41 THz, in ITW—(Sandbjerg, Denmark, Sep. 17-19, 2000)

6. S. E. Korbly, M. A. Shapiro and R. J. Tempkin. A Smith Purcell Radiation Bunch Length Diagnostic, in 27th IEEE International Conference on Infrared and Millimeter Waves (San Diego, Calif., USA, Sep. 22-26, 2002)

7. G. L. Carr, M. C. Martin, W. R. McKinney, K. Jordan, G. Neil et al. Very High Power THz Radiation from Relativistic Electrons, in 27th IEEE International Conference on IMW (San Diego, Cali., USA, Sep. 22-26, 2002).

8. H. Selig and I. Wilke. Electro-optic Sampling of Terahertz Wake Fields, in ITW—(Sandbjerg, Denmark, Sep. 17-19, 2000)

9. J. R. Thorpe, J. Fletcher, J. M. Chamberlain, R. E. Miles, J. Spencer, E. Huq, M. Oldfield and C. Mann. Developments toward the realisation of Submillimetre-Wave Reflex Klystron sources. 9th Int. Conference on Terahertz Electronics (University of VA, 15-16 Oct. 2001).

10. Peter H. Siegel, Harish Manohara, Jimmy Xu, Baohe Chang, Ali Husain and Jim Hone. Design and Fabrication of a 1200 GHz Nanoklystron. 9th Int. Conference on Terahertz Electronics (University of VA, 15-16 Oct. 2001).

11. J. East and G. Haddad. Vacuum Based Sources for THz Applications. 9th Int. Conference on Terahertz Electronics (University of VA, 15-16 Oct. 2001).

12. D. Newsham, A. Smirnov, and D. Yu. Multi-Beam Photonic Band Gap Structure. 27th IEEE International Conference on IMW (San Diego, Calif., USA, Sep. 22-26, 2002).

13. V. P. Shestopalov. “Smith-Purcell effect”. Commack, N.Y., Nova Science Publishers, 1998.

14. “Electron Beams, Diffraction Gratings and Radiation”, J. E. Walsh, Nucl. Inst. and Methods A445, 214-221, (2000).

15. Fujii et al., “Light Scattering Properties”, Optics and Laser Technology, vol. pp. 40-44, Feb. 1984.

16. Wartski et al., “Interference Phenomenon in OTR & Its Applic. to Particle Beams”, J. Appl. Phys. 46(8), 3644-3653 (Aug. 75).

17. V. P. Shestopalov. Difraktsionnaya Elektronika. Kiev: Nauk. Dumka, 1968.

18. V. P. Shestopalov, L. N. Litvinenko, S. A. Masalov, V. P. Sologub. Difraktsiya voln na reshetkakh. Kharkov, published by Kharkov State University, USSR, 1973.

19. Elektronika millimetrovogo i submillimetrovogo diapazonov: sbomik nauchnykh trudov/[redaktsionnaia kollegiia V. P. Shestopalov (otvetstvennyi redaktor) . . . et al.]. Kiev: Nauk. Dumka, 1988. 264 p.

20. J. Urata, J. E. Walsh, and J. H. Brownell. Superradiant Smith-Purcell Emission, Phys. Rev. Lett., 80, p. 516 (1998).

21. “Amplified-spontaneous-emission power oscillation in a beam-wave interaction,” A. Bakhtyari, J. E. Walsh, and J. H. Brownell, Phys. Rev. E 65, 066503 (2002); “Spontaneous Smith-Purcell radiation described through induced surface currents,” J. H. Brownell, J. Walsh, and G. Doucas, Phys. Rev. E 57, 1075 (1998).

22. Kwang-Je Kim and Su-Bing Song. Self-Amplified Spontaneous Emission in Smith-Purcell Free-Electron Lasers. Proceedings of Free Electron Laser Conference 2000.Durham, N.C. USA.

23. I. V. Borovsky, S. V. Zhilkov, N. A. Khizhniak and V. G. Papkovich. Rezonansnoe preobrazovanie ob'emnikh voln v PEV nad dielektricheskoi grebenkoi (Resonance transformation spatial wave into ESW over dielectric grating). SU Journal of technical physics letter JTP, 1988, Vol.14, No. 17.

24. Zhilkov, S. V. and Khizhniak, N .A. O vozbuzhdenii prostranstvenno-periodicheskoi ploskoi strukturi gaussovim volnovim puchkom (Excitation of spatially-periodical flat structure by gauss wave beam). In “Trudy 2-go Vsesoiuznogo soveschaniia po novim metodam uskorenia” (Proceedings of Workshop in Advanced Acceleration Concepts, Nor-Amberd, October 1989). Yerevan, USSR. Published by Yerevan Physics Institute.

25. Zhilkov, S. V. Issledovanie metallo-dielektricheskih struktur v kachestve uskoriayuschei strukturi lazemogo uskoritelia elektronov (Studying of metal-dielectric structures in capacity of accelerating structure of laser electron accelerator). Ph. D. dissertation passed in November 1990 in Moscow Engineering Physics Institute, Moscow, USSR.

26. F. Klappenberger, K. F. Renk, E. Schomburg, R. Summer, S. Ganichev. Fast GaAs Detector for THz Radiation. 27th IEEE International Conference on IMW (San Diego, Calif., USA, Sep. 22-26, 2002).

27. A. R Jha. Very Long Wavelength Infrared (VLWIR) Hg:Cd:Te Photovoltaic Detectors for Remore Sensing and Ballistic Missle Defense. 27th IEEE International Conference on IMW (San Diego, Calif., USA, Sep. 22-26, 2002).

28. Sarnoff Corporation Cathode Ray Tubes

29. K. L. Kelly, J. E. Scharer, M. Laroussi, R. Block, and K. H. Schoenbach, “Measuring Electron Densities in Highly Collisional Plasmas Using a 110 GHz Interferometer”, IEEE Int. Conf. Plasma Science, New Orleans, La., 2000.

30. S. P. Jamison, D. R. Jones, R. C. Issac, B. Hersfeld, J. J. Carey, H. Sandison, G. Vieux, K. Wynne, and D. A. Jaroszynski. Plasma Characterization with Terahertz Pulses in ITW—(Sandbjerg, Denmark, Sep. 17-19, 2000)

31. Package and Personnel Inspection Systems for Installation and Aviation Security. Topic AF03-177 in 2003 AF SBIR solicitation.

32. Precision Targeting. Topic AF03-227 in 2003 AF SBIR solicitation.

33. Standoff Detection of Aerosolized Biological Agents. Topic DTRA03-007 in 2003 DEFENSE THREAT REDUCTION AGENCY SBIR Solicitation.

34. J. F. Holzman, F. E. Vermeulen, A. Y. Elezzabi. Ultrafast all-optical modulation of infrared radiation via metal-semiconductor waveguide structures. Terahertz and Gigahertz Photonics Technical Conference, 19-23 Jul. 1999.

35. Review of photonics switch technology for telecom and space applications, Chi Wu, Jet Propulsion Lab. Terahertz and Gigahertz Photonics Technical Conference, 19-23 Jul. 1999.

What is claimed is:

1. An apparatus for producing the sequence of terahertz electromagnetic pulses by a driven particle beam comprising an initial electromagnetic beam (em-beam) sent to a metal-dielectric structure whereby said em-beam partially transforms into a delayed electromagnetic wave, and a beam of charged particles (cp-beam) is sent to said structure whereby the particles' kinetic energy partially transforms into energy of the delayed electromagnetic wave having the same phase-frequency's characteristics as transformed field of em-beam.
